(19) United States
(12) Patent Application Publication
(10) Pub. No.: US 2025/0355712 A1
(43) Pub. Date: Nov. 20, 2025

(54) PACKET PROCESSING OPTIMIZATION

(71) Applicant: MaxLinear, Inc., Carlsbad, CA (US)

(72) Inventors: Lior Nevo, Even Yehuda (IL); Elad Fernandes, Rishon LeZion (IL); Oren Bakshe, Kiryat-Ono (IL)

(73) Assignee: MaxLinear, Inc., Carlsbad, CA (US)

(21) Appl. No.: 19/213,857

(22) Filed: May 20, 2025

Related U.S. Application Data
(60) Provisional application No. 63/649,864, filed on May 20, 2024.

(51) Int. Cl. G06F 9/50; H04L 43/55

(52) U.S. Cl. CPC G06F 9/5027; G06F 9/5016; H04L 43/55

(57) ABSTRACT

A method may include obtaining, by a hardware, multiple data packets. The method may also include storing, by the hardware, the multiple data packets in an internal memory. The method may further include allocating, by a firmware, a contiguous portion of external memory. The method may also include determining, by the firmware, a particular flow and a segment number associated with individual data packets of the multiple data packets. The method may further include storing, by the firmware, the individual data packets in the external memory to create an aggregated data packet. The storing may be based on the particular flow and the segment number. The method may also include transmitting, by the firmware, the aggregated data packet to a host CPU for processing.

### CROSS REFERENCE TO RELATED APPLICATIONS

This U.S. patent application claims priority to U.S. Provisional Patent Application No. 63/649,864, titled “PACKET PROCESSING OPTIMIZATION,” and filed on May 20, 2024, the disclosure of which is hereby incorporated by reference in its entirety.

### TECHNICAL FIELD

This disclosure generally relates to data processing optimization, and more specifically, to optimizing packet processing in a system.

### BACKGROUND

Unless otherwise indicated herein, the materials described herein are not prior art to the claims in the present application and are not admitted to be prior art by inclusion in this section.

Speed test applications may be used to assess the performance of an internet connection. Some of the speed test applications may be user-initiated speed tests and some of the speed test applications may be internet service provider (ISP)-initiated speed tests. The user-initiated speed tests may be used in determining an end-to-end measurement of the connection, such as between a speed test server and a user device. The user-initiated speed test may be representative of a user experience within the ISP network. In some instances, the user-initiated speed test may be used to identify issues within and/or beyond the ISP network, such as in user devices (e.g., routers, gateways, etc.). The ISP-initiated speed tests may be used to determine performance within the ISP network, such as in infrastructure associated with the ISP network. As such, the ISP-initiated speed tests may be operable to remove influence from user network facts, such as Wi-Fi limitations, particular device limitations, and the like.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining, by a hardware, multiple data packets. The method may also include storing, by the hardware, the multiple data packets in an internal memory. The method may further include allocating, by a firmware, a contiguous portion of external memory. The method may also include determining, by the firmware, a particular flow and a segment number associated with individual data packets of the multiple data packets. The method may further include storing, by the firmware, the individual data packets in the external memory to create an aggregated data packet. The storing may be based on the particular flow and the segment number. The method may also include transmitting, by the firmware, the aggregated data packet to a host CPU for processing.

In another embodiment, a system may include an internal memory, an external memory, a host CPU, a hardware, and a firmware. The hardware may be operable to obtain multiple data packets and store the multiple data packet in the internal memory. The firmware may be operable to allocate a contiguous portion of the external memory. The firmware may also be operable to determine a particular flow and a segment number associated with individual data packets of the multiple data packets. The firmware may further be operable to store the individual data packets in the external memory, based on the particular flow and the segment number, to create an aggregated data packet. The firmware may also be operable to transmit the aggregated data packet to the host CPU for processing.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for performance tuning of a data transform accelerator;

FIG. 2 illustrates a sequence diagram of data packets in a packet processing optimization system;

FIG. 3 illustrates a flowchart of an example method of packet processing optimization; and

FIG. 4 illustrates an example computing device.

### DETAILED DESCRIPTION

In a system that may be operable to obtain and/or process data (e.g., data packets), optimization may include reducing a number of interrupts in the processing device (e.g., a CPU), reads from memory, writes to memory, and so forth. In some instances, particular applications run by the system and/or particular operations performed by the system may be limited by processing power of the CPU, interrupt handling by the CPU, a number of reads and/or writes to and from memory, and so forth.

For example, speed tests may be beneficial to determine a quality of data delivery for a user in an ISP network and/or for the ISP network. In some instances, the speed tests may contribute to determining issues within the network, which may be used to improve customer satisfaction with the ISP and/or improve brand recognition associated with the ISP. Alternatively, or additionally, ISP-initiated speed tests may contribute to maintaining the ISP network which may, in turn, reduce the number of complaints from individual users and associated costs (e.g., technician visits, discounts for service interruptions, etc.).

In some instances, a user-initiated speed test may be used to measure traffic between ports. As such, routers and/or gateways associated with the user and/or the user network may include hardware accelerators operable to support high bandwidth communications. Alternatively, or additionally, an ISP-initiated speed test may be terminated at a gateway CPU, where hardware accelerators may not be used in the speed test. In such instances, the CPU performance may be less effective than the hardware accelerator associated with the user-initiated speed test. As such, reducing the load on the CPU may be a factor to performance improvement in the ISP-initiated speed test.

Some prior approaches aimed to improve efficiency and/or performance (e.g., such as in a TCP/IP network) by implementing various optimization techniques, including large receive offload (LRO) technique or generic receive offload (GRO) technique. The LRO technique may target hardware offloading in a TCP/IP network using network interface cards (NICs). Using the LRO technique, CPU overhead may be reduced as multiple incoming packets may be combined into a larger packet prior to delivery (of the larger packet) to the CPU. The GRO technique may be a software-based alternative to the LRO technique. The GRO technique may be implemented in the operating system kernel and may provide software-based packet aggregation. As such, the GRO technique may provide more flexibility and/or control in the network optimization relative to the LRO technique, which may facilitate more configuration and/or adaptation in the TCP/IP network optimization.

Both the LRO technique and the GRO technique may include drawbacks relative to one another. For example, the GRO technique may be a more flexible optimization technique relative to the LRO technique, as the GRO technique may be implemented in software, whereas the LRO technique may be implemented in hardware. As such, the GRO technique may facilitate customized packet aggregation behavior based on conditions of the TCP/IP network and/or particular application needs. In another example, the LRO technique may have limited configuration options (due to the hardware implementation), where in some cases, the LRO technique may be limited to either operations being enabled or disabled (e.g., no additional configurations aside from on or off).

Alternatively, or additionally, the GRO technique may not be able to attain a similar level of performance as the LRO technique. Further, the GRO technique may introduce additional CPU overhead to the system relative to the LRO technique, as the optimization performed using the GRO technique is software based and performed by the CPU in the system.

Alternatively, or additionally, both the LRO technique and the GRO technique may incur a heavy load on memory access (e.g., double data rate (DDR) memory) in the system. For example, temporarily storing the incoming packets in the memory prior to any processing and/or delivery incurs a heavy load on the memory. Further, the assembly of the larger packet in one contiguous buffer in the same memory may result in additional and/or unnecessary reads and/or writes by the system. In such instances, the CPU bandwidth limit may be replaced by a memory bandwidth limit, which may be more expensive and/or may need more expensive memory to accommodate the increased memory demands.

At least one aspect of the present disclosure may include hardware operable to obtain packets and store the packets in an internal memory in a system. The hardware may notify firmware included in the system that the packets are stored in the internal memory, and the firmware may copy portions of the packets into an external memory, such as a buffer. The copied packets may be aggregated into a larger, aggregated data packet within the external memory and the firmware may notify a processing device (e.g., a CPU) that the aggregated data packet is available for processing. In such instances, the system may be operable to utilize the speed associated with hardware (e.g., similar to the LRO technique) and/or the adaptability associated with software (e.g., similar to the GRO technique) in processing packets, while improving operation of the processing device and/or the buffer in the system.

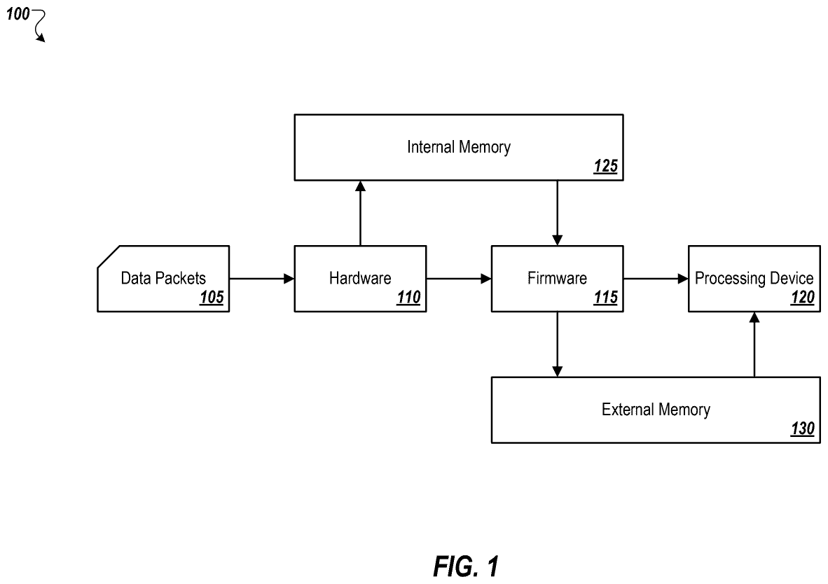

FIG. 1 illustrates a block diagram of an example system 100 for optimizing packet processing, such as in a TCP/IP network. The system 100 may include hardware 110, firmware 115, a processing device 120, an internal memory 125, and an external memory 130.

In some instances, the hardware 110 may be operable to obtain data packets 105 and/or other data that may be transmitted using various protocols and/or techniques. For example, the data packets 105 may associated with a wide area network, a local area network, such as a TCP/IP system, a wireless Ethernet system, a wired Ethernet system, a switch device in a system, and/or other networks and systems. In the present disclosure, the transmitted data obtained by the system 100 may be referred to as the data packets 105, where it is understood that any manners of data transmission may be used. In some instances, the data packets 105 may be maximum transmission unit data packets.

In some instances, the hardware 110 may be a network interface controller (NIC) that may be operable to obtain data packets 105 transmitted to the system 100. For example, the hardware 110 may be a NIC that may be the same or similar to hardware used in the LRO technique and may be operable to perform a similar function. In some instances, the data packets 105 may be in accordance with the TCP/IP network protocol. The hardware 110 may be operable to perform the initial processing associated with obtaining the data packets 105.

Subsequent to obtaining the data packets 105, the hardware 110 may be operable direct the data packets 105 to be stored in the internal memory 125. The internal memory 125 may be any data storage device that may be configured to store the data packets 105. For example, in some instances, the internal memory 125 may be static random-access memory (SRAM). Alternatively, or additionally, the hardware 110 may be operable to transmit a notification to the firmware 115 which may provide an indication to the firmware 115 that at least one packet of the data packets 105 may have been stored in the internal memory 125. In some instances, the internal memory 125 may be referred to as “internal” due to its location relative to the other components. In other words, the internal memory 125 may be on-chip memory, or on a same chip as at least the processing device 120. Alternatively, or additionally, the external memory 130 may be referred to as “external” as it may be an attached memory, or in other words, the external memory 130 may be off-chip memory. In some instances, the internal memory 125 may be smaller (in terms of an amount of data that may be stored therein) and/or faster (e.g., read speed and/or write speed) relative to the external memory 130.

In some instances, the firmware 115 may be operable to allocate a contiguous portion of the external memory 130 for storing one or more of the data packets 105, such that the data packets 105 may be aggregated into an aggregated data packet. In some instances, the contiguous portion of the external memory 130 may be sized based on an amount of data that the processing device 120 may be configured to use. For example, the processing device 120 may be configured to optimally consume an aggregated data packet of a particular size and the firmware 115 may allocate the contiguous portion of the external memory 130 to be the same or similar as the particular size for the processing device 120.

In some instances, the firmware 115 may be operable to obtain the data packets 105 from the internal memory 125 and store the data packets 105 in the external memory 130. In some instances, the firmware 115 may be operable to determine a particular flow that each individual data packet may be associated with. Alternatively, or additionally, the firmware 115 may be operable to determine a segment number associated with each individual data packet. Using the particular flow and/or the segment number associated with each individual data packet, the firmware 115 may be operable to store the data packets 105 that each belong to the particular flow and/or the firmware 115 may arrange the data packets 105 based on the segment number (e.g., sequentially) such that the aggregated data packet may be arranged in a sequential order. For example, in instances in which the firmware 115 determines a first packet of the data packets 105 belongs to a first flow and a second packet of the data packets 105 belongs to a second flow, the firmware 115 may direct the first packet to be stored in the external memory 130 (e.g., to be included in the aggregated packet associated with the first flow, as described), and the firmware 115 may leave the second packet in the internal memory 125. In such instances, the firmware 115 may subsequently direct the second packet to be stored in the external memory 130, such as when additional data packets 105 belonging to the second flow may be available to be stored in external memory 130 (e.g., such that the aggregated packet may be associated with the second flow).

In some instances, the firmware 115 may be operable to perform the same or similar operations as the software in the GRO technique. As such, the firmware 115 may be operable to adjust the aggregation of the data packets 105, such as to improve efficiency in the system 100. For example, the firmware 115 may be operable to resize the contiguous portion of the external memory 130 based on changed specifications of the processing device 120. For example, in instances in which the processing device 120 experiences a change in processing capabilities (e.g., decreased processing power due to degradation over time), the firmware 115 may adjust the contiguous portion of the external memory 130 in view of the change to the processing device 120. In another example, the firmware 115 may be operable to resize the contiguous portion of the external memory 130 based on the operations performed by the system 100. For example, in instances in which the system 100 is being used for a speed test (e.g., and the data packets 105 are used in the speed test), the firmware 115 may allocate the contiguous portion of the external memory 130 to optimize for the speed test.

The firmware 115 may be operable to copy data from the internal memory 125 into the external memory 130. The firmware 115 may copy one or more packets (e.g., segments, or other portions of the data packets 105) of the data packets 105 stored in the internal memory 125 to generate an aggregated data packet in the external memory 130. The aggregated data packet may be an aggregation of the data packets 105 that may be combined prior to the processing device 120 obtaining the aggregated data packet for processing. In some instances, the firmware 115 may provide flexibility to the system 100 in the processing of the data packets 105, such as by varying the number of the data packets 105 to be included in the aggregated data packet prior to processing by the processing device 120. For example, in a first instance, the firmware 115 may include a fewer number of the data packets 105 in the larger packet, which may reduce the bandwidth usage of the external memory 130 (e.g., the external memory 130 may be less capable than the processing device 120 at handling a larger processing load). In a second example, the firmware 115 may include a greater number of the data packets 105 in the aggregated data packet to reduce the bandwidth usage of the processing device 120 (e.g., the external memory 130 may be more capable than the processing device 120 at handling a larger processing load). In these and other instances, the firmware 115 may be operable to automatically make adjustments to the system 100 and/or the packet processing within the system 100 based on needs of the system 100 (e.g., the bandwidth availability of the processing device 120 and/or the external memory 130).

As described, the external memory 130 may obtain one or more of the data packets 105 that may have been stored in the internal memory 125, as directed by the firmware 115. The external memory 130 may store the data packets 105 until the aggregated data packet is generated (e.g., the combining of one or more packets obtained from the internal memory 125 into one larger packet for processing by the processing device 120). In some instances, the external memory 130 may be double data rate (DDR) memory. Alternatively, or additionally, the external memory 130 may be high bandwidth memory, or any other high speed memory suitable for storing and/or aggregating data.

In some instances, the external memory 130 may continue to obtain the data packets 105 from the internal memory 125, as directed by the firmware 115, until a threshold may be satisfied. For example, the external memory 130 may aggregate the data packets 105 until the contiguous portion of the external memory 130 is full. In another example, the external memory 130 may aggregate the data packets 105 until a predetermined amount of time may have elapsed. In some instances, the predetermined amount of time may be based on performance of the processing device 120, a rate at which the data packets 105 may be received, a rate at which the data packets 105 may be read or written to the internal memory 125 and/or the external memory 130, and/or other factors associated with the system 100.

In some instances, the processing device 120 may be operable to process the aggregated packet obtained from the external memory 130. In some instances, the processing device 120 may obtain a notification from the firmware 115 that the larger packet in the external memory 130 may be available for processing.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

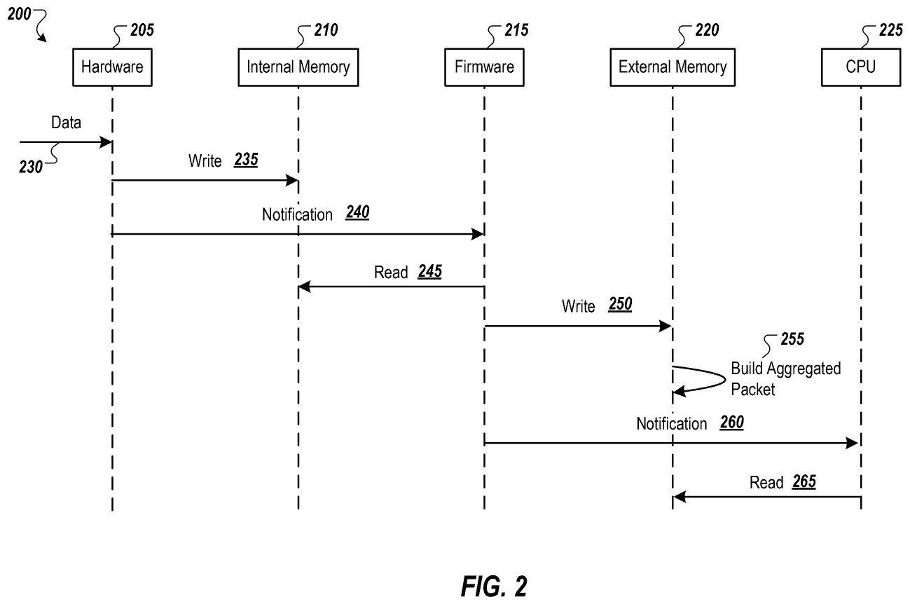

FIG. 2 illustrates a sequence diagram 200 of data packets in a packet processing optimization system, such as the system 100 of FIG. 1. The sequence diagram 200 may include hardware 205, internal memory 210, firmware 215, external memory 220, and a CPU 225. In some instances, the hardware 205, the internal memory 210, the firmware 215, the external memory 220, and the CPU 225 may be the same or similar as the hardware 110, the internal memory 125, the firmware 115, the external memory 130, and the processing device 120 of FIG. 1, respectively. In such instances, the hardware 205, the internal memory 210, the firmware 215, the external memory 220, and the CPU 225 may be operable to perform the same or similar operations as the hardware 110, the internal memory 125, the firmware 115, the external memory 130, and the processing device 120, respectively.

The sequence diagram 200 may begin with data packets 230 being obtained by the hardware 205. The hardware 205 may write 235 the data packets to the internal memory 210. Alternatively, or additionally, the hardware 205 may be operable to transmit a notification 240 to the firmware 215, such that the firmware 215 may be aware of the data packets stored in the internal memory 210.

The firmware 215 may be operable to read 245 the internal memory 210 to obtain the data packets stored therein. In some instances, the firmware 215 may be operable to write 250 the obtained data packets to the external memory 220. As the firmware 215 continues to write 250 data packets to the external memory 220, an aggregated data packet may be generated 255 within the external memory 220. In some instances, the firmware 215 may transmit a notification 260 (e.g., an interrupt) to the CPU 225 to alert the CPU 225 that the aggregated data packet in the external memory 220 may be available to be read. In some instances, the CPU 225 may read 265 the aggregated data packet from the external memory 220.

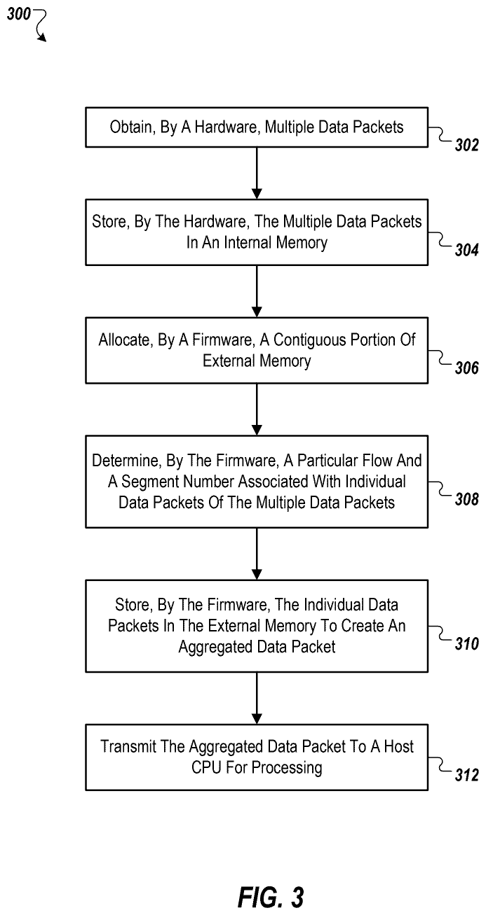

FIG. 3 illustrates a flowchart of an example method 300 of optimizing packet processing in a network, in accordance with at least one embodiment of the present disclosure. The method 300 may be performed by processing logic that may include hardware (circuitry, dedicated logic, etc.), software (such as is run on a general purpose computer system or a dedicated machine), or a combination of both, which processing logic may be included in any computer system or device such as the system 100 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method may begin at block 302 multiple data packets may be obtained by a hardware. In some instances, the hardware may be a network interface card that may be operable to receive the multiple data packets via a local area network or a wide area network. In some instances, the multiple data packets may be generated as part of a network-based speed test. The network-based speed test may be a user-run speed test or may be an internet service provider speed test. In some instances, the multiple data packets may be maximum transmission unit data packets.

At block 304, the multiple data packets may be stored in an internal memory by the hardware. In some instances, the internal memory may be is static random access memory.

At block 306, a contiguous portion of external memory may be allocated by a firmware. In some instances, the external memory may be double data rate memory or high bandwidth memory. In some instances, the firmware may make an adjustment to the allocated contiguous portion of external memory based on an operation associated with the multiple data packets and/or a specification of the host CPU.

At block 308, a particular flow and/or a segment number associated with individual data packets of the multiple data packets may be determined by the firmware.

At block 310, the individual data packets may be stored in the external memory by the firmware to create an aggregated data packet. In some instances, the individual data packets may be stored based on the particular flow and/or the segment number. In some instances, the aggregated data packet is transmitted to a host CPU once the external memory is full, based on a size of the contiguous chunk portion of the external memory. Alternatively, or additionally, the aggregated data packet may be transmitted to the host CPU after a predetermined amount of time has elapsed. In some instances, in response to a first individual data packet belonging to a first flow and a second individual data packet belonging to a second flow, the firmware may store the first individual data packet in the external memory and the firmware may not store the second individual data packet in the external memory.

At block 312, the aggregated data packet may be transmitted to the host CPU for processing. In some instances, the host CPU may obtain more than one individual data packet of the multiple data packets using one interrupt and/or one read operation of the external memory.

Modifications, additions, or omissions may be made to the method 300 without departing from the scope of the present disclosure. For example, the designations of different elements in the manner described is meant to help explain concepts described herein and is not limiting. Further, the method 300 may include any number of other elements or may be implemented within other systems or contexts than those described.

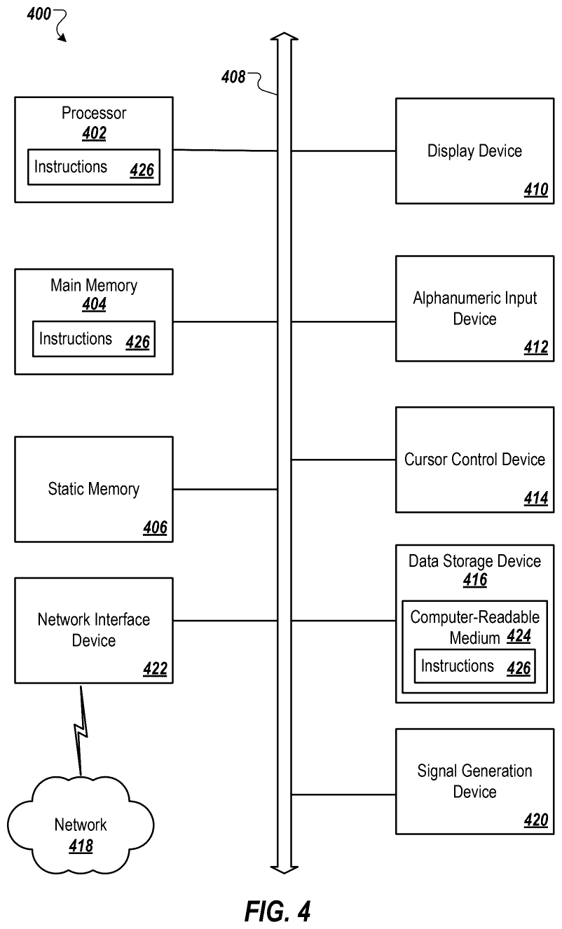

FIG. 4 illustrates an example computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 400 includes a processing device 402 (e.g., a processor), a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

The processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one implementation, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over the network 418 via the network interface device 422.

While the computer-readable storage medium 424 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining, by a hardware, a plurality of data packets;
storing, by the hardware, the plurality of data packets in an internal memory;
allocating, by a firmware, a contiguous portion of external memory;
determining, by the firmware, a particular flow and a segment number associated with individual data packets of the plurality of data packets;
storing, by the firmware, the individual data packets in the external memory, based on the particular flow and the segment number, to create an aggregated data packet; and
transmitting, by the firmware, the aggregated data packet to a host CPU for processing.

2. The method of claim 1, wherein the hardware is a network interface card operable to receive the plurality of data packets via a local area network or a wide area network.

3. The method of claim 1, wherein the plurality of data packets are generated as part of a network-based speed test.

4. The method of claim 3, wherein the network-based speed test is a user-run speed test or an internet service provider speed test.

5. The method of claim 1, wherein the plurality of data packets are maximum transmission unit data packets.

6. The method of claim 1, wherein the internal memory is static random access memory and the external memory is double data rate memory or high bandwidth memory.

7. The method of claim 1, wherein the aggregated data packet is transmitted to the host CPU once the external memory is full, based on a size of the contiguous portion of the external memory.

8. The method of claim 1, wherein the aggregated data packet is transmitted to the host CPU after a predetermined amount of time has elapsed.

9. The method of claim 1, wherein the host CPU obtains more than one individual data packet of the plurality of data packets using one interrupt and one read operation of the external memory.

10. The method of claim 1, wherein in response to a first individual data packet belonging to a first flow and a second individual data packet belonging to a second flow, the firmware stores the first individual data packet in the external memory and the firmware does not store the second individual data packet in the external memory.

11. The method of claim 1, wherein the firmware makes an adjustment to the allocated contiguous portion of external memory based on an operation associated with the plurality of data packets or a specification of the host CPU.

12. A system, comprising:
an internal memory;
an external memory;
a host CPU;
a hardware operable to obtain a plurality of data packets and store the plurality of data packet in the internal memory; and
a firmware operable to:
allocate a contiguous portion of the external memory;
determine a particular flow and a segment number associated with individual data packets of the plurality of data packets;
store the individual data packets in the external memory, based on the particular flow and the segment number, to create an aggregated data packet; and
transmit the aggregated data packet to the host CPU for processing.

13. The system of claim 12, wherein the hardware is a network interface card operable to receive the plurality of data packets via a local area network or a wide area network.

14. The system of claim 12, wherein the plurality of data packets are maximum transmission unit data packets.

15. The system of claim 12, wherein the internal memory is static random access memory and the external memory is double data rate memory or high bandwidth memory.

16. The system of claim 12, wherein the aggregated data packet is transmitted to the host CPU once the external memory is full, based on a size of the contiguous portion of the external memory.

17. The system of claim 12, wherein the aggregated data packet is transmitted to the host CPU after a predetermined amount of time has elapsed.

18. The system of claim 12, wherein the host CPU obtains more than one individual data packet of the plurality of data packets using one interrupt and one read operation of the external memory.

19. The system of claim 12, wherein in response to a first individual data packet belonging to a first flow and a second individual data packet belonging to a second flow, the firmware stores the first individual data packet in the external memory and the firmware does not store the second individual data packet in the external memory.

20. The system of claim 12, wherein the firmware makes an adjustment to the allocated contiguous portion of external memory based on an operation associated with the plurality of data packets or a specification of the host CPU.
